(19) United States
(12) Patent Application Publication
(10) Pub. No.: US 2010/0252709 A1
(43) Pub. Date: Oct. 7, 2010

(54) REUSABLE HOOK STRUCTURE

(76) Inventor: Mao Hsu WENG, Tucheng City (TW)

Correspondence Address: SINORICA, LLC, 2275 Research Blvd., Suite 500, ROCKVILLE, MD, 20850, US

(21) Appl. No.: 12/726,547

(22) Filed: Mar. 18, 2010

(30) Foreign Application Priority Data
Apr. 7, 2009 (TW) 098205615

(51) Int. Cl. F16B 45/00

(52) U.S. Cl. 248/304

(57) ABSTRACT

A reusable hook structure includes a combined plate unit and a hook body. The combined plate unit includes an attachable resilient plate and a pattern plate. One side of the attachable resilient plate is coupled to one side of the pattern plate. The hook body has a coupling surface and a hook portion. The coupling surface is coupled to another side of the pattern plate of the combined plate unit. The surface tension from the attachable resilient plate of the combined unit provides a stable adsorbability for another side of the attachable resilient plate to be attached to a smooth wall surface. The mist and steam on the wall surface won't permeate through the attachable resilient plate to influence the adsorbability of the attachable resilient plate. When the suction force between the attachable resilient plate and the wall surface is withdrawn, the combined plate unit will be removed from the wall surface for the hook structure to be reused to another smooth wall surface, providing convenient and stable effects.

### BACKGROUND OF THE INVENTION

1. Field of the Invention

The present invention relates to a reusable hook structure.

2. Description of the Prior Art

As shown in FIG. 5, a conventional hook (40) comprises an attachable member (41) and a hook member (42). By pulling the hook member (42), the attachable member (41) is pushed inward to generate a suction force relative to a wall surface, so that the hook (40) is attached to the wall surface. Another conventional hook is provided with an adhesive member (not shown in the drawing) behind the hook member (42). The hook (42) is attached to the wall surface through the adhesive member. However, the conventional hook has some shortcomings as follows:

1. It is not convenient for use. By pulling the hook member, the attachable member is pushed to generate a suction force relative to the wall surface for the hook to be attached to the wall surface. After a period of time, the suction force will gradually disappear. As to the hook with the adhesive member, the adhesive member will lose its adhesion force when the wall surface is wet.

2. It is not stable for coupling. After a period of time, the suction force between the attachable member and the wall surface will gradually disappear. The attachable member may lose its adsorptive effect, resulting in that the hook falls from the wall surface.

Accordingly, the inventor of the present invention has devoted himself based on his many years of practical experiences to develop a reusable hook structure.

### SUMMARY OF THE INVENTION

The present invention is to provide a reusable hook structure which comprises a combined plate unit and a hook body. The combined plate unit includes an attachable resilient plate and a pattern plate. The attachable resilient plate is made of resilience resign. The hook body has a coupling surface and a hook portion. One side of the attachable resilient plate is coupled to one side of the pattern plate. The coupling surface of the hook body is coupled to another side of the pattern plate of the combined plate unit. The surface tension from the attachable resilient plate of the combined unit provides a stable adsorbability for another side of the attachable resilient plate to be attached to a smooth wall surface. The mist and steam on the wall surface won't permeate through the attachable resilient plate to influence the adsorbability of the attachable resilient plate. When the suction force between the attachable resilient plate and the wall surface is withdrawn, the combined plate unit will be removed from the wall surface for the hook structure to be reused to another smooth wall surface, providing convenient and stable effects.

### BRIEF DESCRIPTION OF THE DRAWINGS

FIG. 1 is a perspective view according to a first embodiment of the present invention;

FIG. 2 is an exploded view according to the first embodiment of the present invention;

FIG. 3 is a side view according to the first embodiment of the present invention when in use;

FIG. 4 is a perspective view according to a second embodiment of the present invention; and

FIG. 5 is a perspective view of a conventional hook.

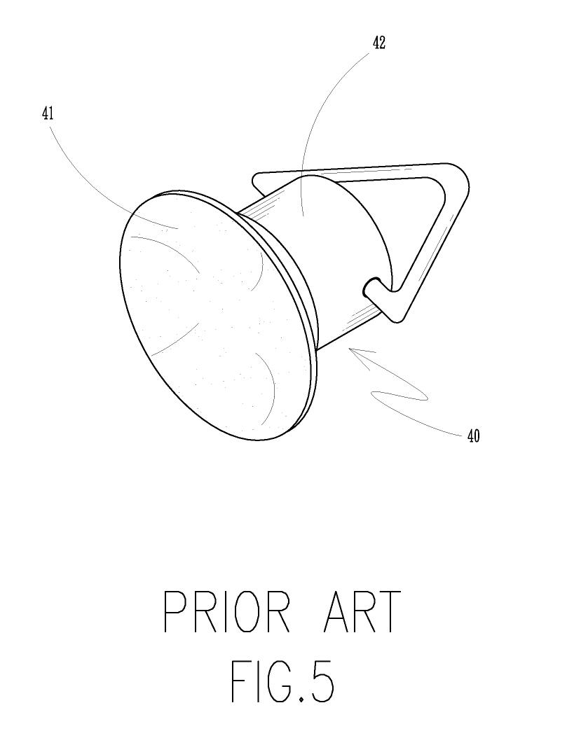

### DETAILED DESCRIPTION OF THE PREFERRED EMBODIMENTS

Embodiments of the present invention will now be described, by way of example only, with reference to the accompanying drawings.

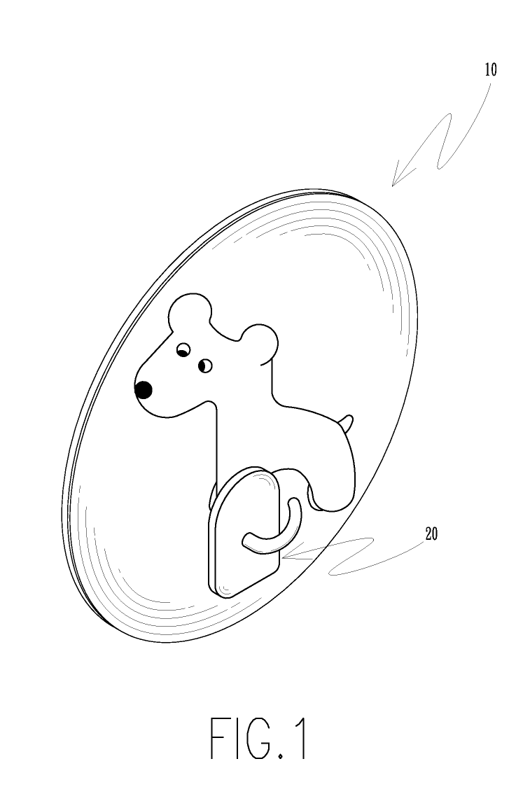

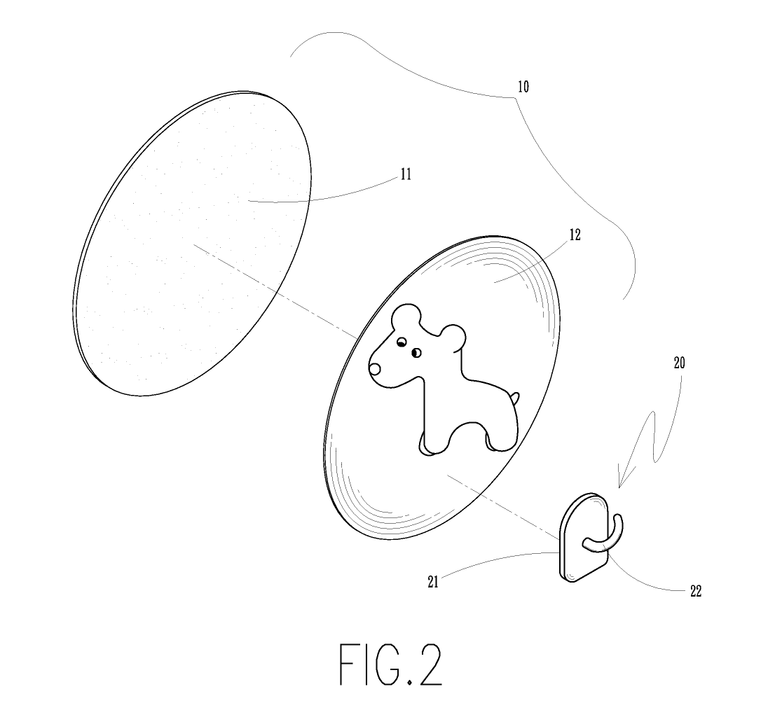

As shown in FIG. 1 to FIG. 2, a reusable hook structure according to a first embodiment of the present invention comprises a combined plate unit (10) and a hook body (20).

The combined plate unit (10) includes an attachable resilient plate (11) and a pattern plate (12). The attachable resilient plate (11) is made of resilience resign. The pattern plate (12) is made of polyvinyl chloride (PVC) printing plate. One side of the attachable resilient plate (11) is coupled to one side of the pattern plate (12).

The hook body (20) has a coupling surface (21) and a hook portion (22). The coupling surface (21) is coupled to another side of the pattern plate (12) of the combined plate unit (10).

By the aforesaid configuration, the reusable hook structure of the present invention is completed.

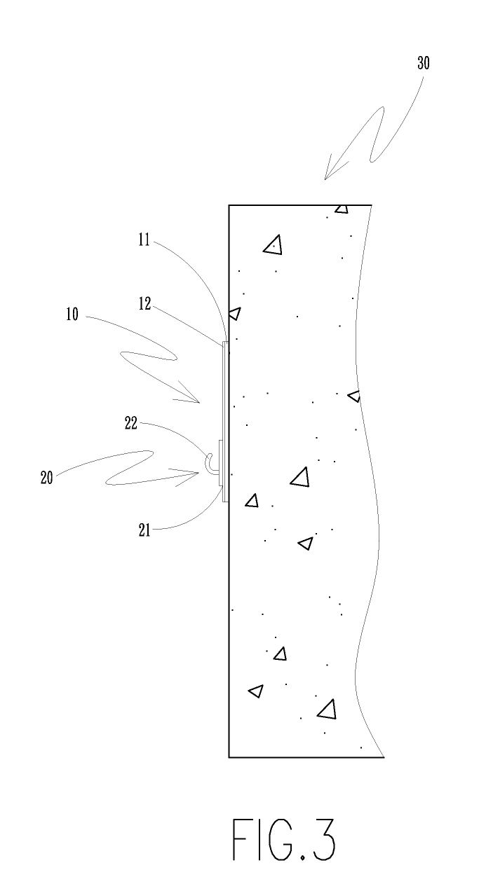

FIG. 3 is a schematic view showing the reusable hook structure of the present invention when in us. One side of the attachable resilient plate (11) of the combined plate unit (10) is coupled to the pattern plate (12). The coupling surface (21) of the hook body (20) is coupled to another side of the pattern plate (12). Another side of the attachable resilient plate (11) of the combined plate unit (10) is securely attached to a smooth wall surface (30) through its surface tension. The mist and steam on the wall surface won't permeate through the attachable resilient plate (11) to influence the adsorbability of the attachable resilient plate (11). When the suction force between the attachable resilient plate (11) and the wall surface (30) is withdrawn, the combined plate unit (10) will be removed from the wall surface (30). In this way, the hook structure of the present invention can be reused to another smooth wall surface (30), providing convenient and stable effect.

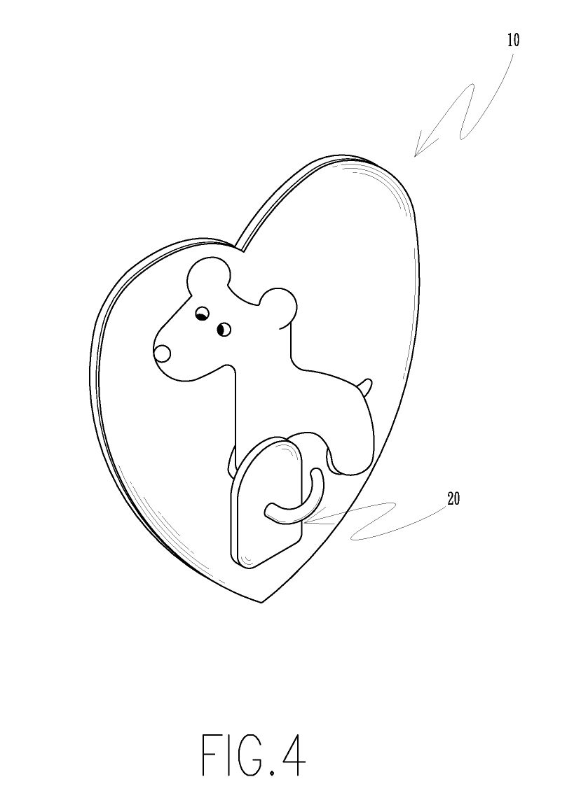

FIG. 4 is a perspective view showing a second embodiment of the reusable hook structure of the present invention. The second embodiment is substantially similar to the first embodiment as shown in FIG. 1 to FIG. 3 with the exceptions described hereinafter. The attachable resilient plate (11) and the pattern plate (12) of the combined plate unit (10) can be in different shapes to enhance the practicability of the present invention.

The advantages of the present invention are as follows:

1. It is very convenient for use. When the suction force between the attachable resilient plate and the wall surface is withdrawn, the combined plate unit will be removed from the wall surface for the hook structure to be reused to another smooth wall surface.

2. It is stable for coupling. The surface tension from the attachable resilient plate of the combined unit provides a stable adsorbability for another side of the attachable resilient plate to be attached to the smooth wall surface. The mist and steam on the wall surface won't permeate through the attachable resilient plate to influence the adsorbability of the attachable resilient plate.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A reusable hook structure, comprising:
a combined plate unit, the combined plate unit including an attachable resilient plate and a pattern plate, one side of the attachable resilient plate being coupled to one side of the pattern plate; and
a hook body, the hook body having a coupling surface and a hook portion, the coupling surface being coupled to another side of the pattern plate of the combined plate unit.

2. The reusable hook structure as claimed in claim 1, wherein the attachable resilient plate is made of resilience resign.

3. The reusable hook structure as claimed in claim 1, wherein the pattern plate is made of polyvinyl chloride (PVC) printing plate.
